(19) United States
(12) Patent Application Publication
(10) Pub. No.: US 2008/0317628 A1
(43) Pub. Date: Dec. 25, 2008

(54) CHECK SHEET

(75) Inventors: Hideyasu ISHIBASHI, Kanagawa (JP); Yoshiki Sakaino, Tokyo (JP); Hiroshi Yamaguchi, Kanagawa (JP); Hiroyuki Niwano, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/142,473

(22) Filed: Jun. 19, 2008

(30) Foreign Application Priority Data
Jun. 19, 2007 (JP) 2007-161713
May 29, 2008 (JP) 2008-141670

(51) Int. Cl. G01N 21/78

(52) U.S. Cl. 422/55

(57) ABSTRACT

A check sheet includes: a reagent container that contains a reagent that changes color by being brought into contact with a target element generated from skin; and a plurality of filters provided in different positions from each other at the opposite side to the side of the reagent container to be attached to the skin along the reagent container, and emitting light in wavelength regions different from each other. A check sheet includes: a reagent container that contains a reagent that changes color by being brought into contact with a target element generated from skin; and a filter provided at the opposite side to the side of the reagent container to be attached to the skin, and transmitting light in a part of a wavelength region detectable by a light detector detecting a color of the reagent.

### CROSS REFERENCE TO RELATED APPLICATION

The present application claims priority from a Japanese Patent Applications No. 2007-161713 filed on Jun. 19, 2007, and No. 2008-141670 filed on May 29, 2008, the contents of which are incorporated herein by reference.

### BACKGROUND

1. Technical Field

The present invention relates to a check sheet. In particular, the present invention relates to a check sheet containing a reagent that changes color by being brought in contact with a target element generated from skin.

2. Related Art

Japanese Patent No. 3424009 discloses an analyzing apparatus for analyzing a test specimen, by emitting, to the test specimen, fluorescence having its peak in a wavelength band in which the sensitivity of the light receiving element receiving light in the wavelength regions of R component, G component, and B component has its peak. Japanese Patent Application Publication No. 05-209836 discloses an analyzing apparatus for analyzing a test layer, by irradiating, to a reagent layer, light having its peak intensity in the wavelength regions of R component, G component, and B component.

However, in the inventions respectively disclosed in Japanese Patent No. 3424009 and Japanese Patent Application Publication No. 05-209836, if the light receiving element detected as the color of the reagent is different, it is occasionally difficult to identify the exact color of the reagent, due to variations in spectroscopic characteristics respectively of an R component filter, a G component filter, and a B component filter of each light receiving element.

### SUMMARY

In view of this, it is an object of one aspect of the present invention to provide a check sheet capable of solving the foregoing problems. This object is achieved by combinations of features described in the independent claims. The dependent claims define further advantageous and concrete examples of the present invention.

According to the first aspect related to the innovations herein, one exemplary check sheet includes: a reagent container that contains a reagent that changes color by being brought into contact with a target element generated from skin; and a plurality of filters provided in different positions from each other at the opposite side to the side of the reagent container to be attached to the skin along the reagent container, and emitting light in wavelength regions different from each other. It is also possible to arrange so that the plurality of filters transmit light in a wavelength region representing a color of the reagent before change of color or a color of the reagent after change of color.

According to another aspect related to the innovations herein, one exemplary check sheet includes: a reagent container that contains a reagent that changes color by being brought into contact with a target element generated from skin; and a filter provided at the opposite side to the side of the reagent container to be attached to the skin, and transmitting light in a part of a wavelength region detectable by a light detector detecting a color of the reagent. It is also possible to arrange so that the light detector includes a first detecting element and a second detecting element respectively capable of detecting a first color component and a second color component of light; and the filter does not transmit light in a wavelength region detectable by both of the first detecting element and the second detecting element.

The summary clause does not necessarily describe all necessary features of the embodiments of the present invention. The present invention may also be a sub-combination of the features described above.

### BRIEF DESCRIPTION OF THE DRAWINGS

FIG. 1 is a schematic view of a check system.

FIG. 2 is a block diagram showing a functional configuration of an image capturing apparatus 20.

FIG. 3 is a conceptual diagram showing transmission characteristics of a plurality of filters 102.

FIGS. 4A and 4B show a check sheet 10.

FIG. 5 shows a check sheet 10.

FIGS. 6A and 6B show a check sheet 10.

FIGS. 7A and 7B show a check sheet 10.

FIG. 8 is a sectional view of a check sheet 10.

FIG. 9 shows another example of the transmission characteristics of a plurality of filters 102.

FIGS. 10A and 10B show a check sheet 10.

FIG. 11 is a schematic view of a check system.

FIG. 12 shows a check sheet 10.

FIG. 13 is a sectional view of a check sheet 10.

FIG. 14 is a sectional view of a check sheet 10.

FIG. 15 is a sectional view of a check sheet 10.

FIG. 16 shows a check sheet 10.

### DESCRIPTION OF EXEMPLARY EMBODIMENTS

Some aspects of the invention will now be described based on the embodiments, which do not intend to limit the scope of the present invention, but exemplify the invention. All of the features and the combinations thereof described in the embodiment are not necessarily essential to the invention.

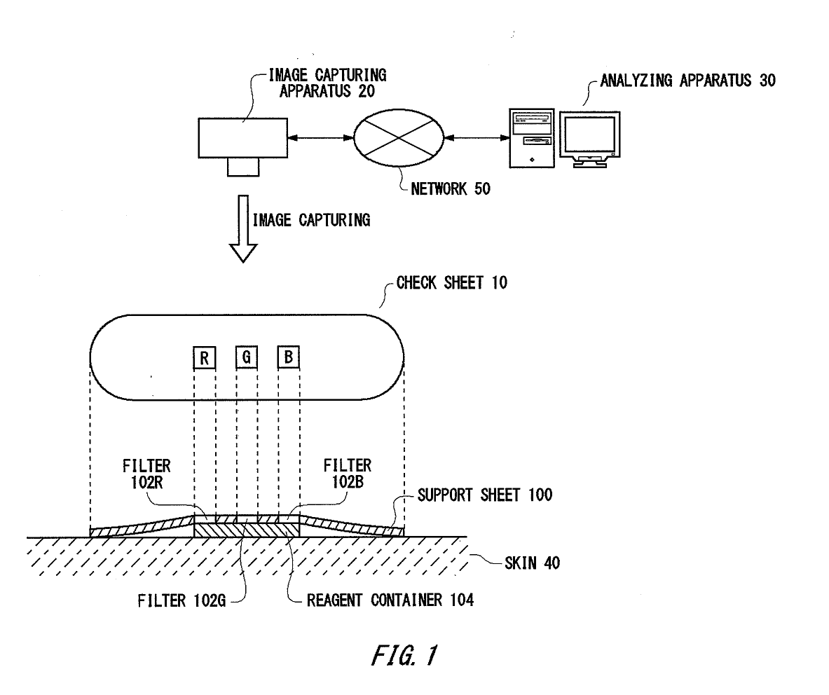

FIG. 1 shows an exemplary check system using a check sheet 10 according to an embodiment of the present invention. The check system captures an image of the check sheet 10 attached to skin 40 by means of an image capturing apparatus 20, for checking the condition of the skin 40. The check system includes a check sheet 10, an image capturing apparatus 20, and an analyzing apparatus 30. The check sheet 10 includes a support sheet 100, a plurality of filters 102, and a reagent container 104. The check sheet 10 and the check system according to the present embodiment are for assuredly detecting a phenomenon caused for the skin 40, even when any of a plurality of image capturing apparatuses 20 different from each other is used to capture a color change of the check sheet 10.

First, the check sheet 10 is attached to skin 40 of a human body. The reagent contained in the reagent container 104 changes its color due to existence of water or sebum on the surface of the skin 40 included in part of the region where the check sheet 10 is attached. Each filter 102 selectively transmits light in a predetermined wavelength region depending on its spectroscopic characteristic. Next, the image capturing apparatus 20 captures an image of light in a wavelength region transmitted through each filter 102, thereby transmitting captured image data showing the captured image, through a network 50 to the analyzing apparatus 30. The analyzing apparatus 30 analyzes the condition of the skin 40, from the captured image shown by the captured image data.

To be more specific, the support sheet 100 of the check sheet 10 retains the reagent container 104 and the filters 102. The support sheet 100 may be a polymeric resin sheet, e.g. polyvinyl chloride, polyvinyl alcohol, polyester, polyethylene, polypropylene, polyurethane, polyolefin, and a polyamide synthetic fiber. The polymerization degree, the average molecular weight, etc. of the polymeric resin sheet can be determined in accordance with the usage conditions of the check sheet 10, the flexibility, durability, or the like required of the check sheet 10, as necessary. In addition, prior to usage of the check sheet 10, a protective sheet is attached to a surface of the support sheet 100 to be attached to the skin 40. In actual usage of the check sheet 10, the protective sheet is removed to attach the check sheet 10 to the skin 40.

The reagent container 104 of the check sheet 10 retains a reagent that changes its color by being in contact with a target element generated or discharged from skin. Some examples of the target element are water, perspiration, or sebum on skin. The reagent contained in the reagent container 104 may be a compound that changes its color by absorbing water, perspiration, or sebum. For example, when the target element is water, the reagent may be anhydrous copper sulfate or cobalt chloride. The reagent may be a pH indicator. Between the reagent container 104 and the skin 40, the check sheet 10 may be provided with a layer such as nonwoven fabric that transmits water or sebum, but does not transmit a reagent, for preventing direct contact between the reagent and the skin 40. The example of FIG. 1 shows an exemplary check sheet 10 having one kind of reagent container 104. However another exemplary check sheet 10 may have a plurality of reagent containers 104 for containing different kinds of reagents respectively.

The plurality of filters 102, e.g. a filter 102R, a filter 102G, a filter 102B, are provided at different positions from each other, along the reagent container 104 on the side of the reagent container 104 opposite to the side that is attached to the skin 40. The filter 102R, the filter 102G, and the filter 102B transmit light in different wavelength regions from each other. Specifically, each filter 102 transmits light in a part of each of a plurality of wavelength regions detectable by a light detector 204 of the image capturing apparatus 20 detecting the color of the reagent. The check sheet 10 may further be provided with an infrared light transmission filter 114 to be visible from outside together with the reagent container 104, and to transmit infrared light from the skin 40.

More specifically, the light detector 204 includes a first detecting element, a second detecting element, and a third detecting element respectively capable of detecting a first color component, a second color component, and a third color component of light. Note that each of the first, second and third detecting elements has a filter 206 for transmitting light in a predetermined wavelength region onto a light receiving surface. Concretely, the first detecting element has a first filter 206 transmitting light of the first color component. Likewise, the second detecting element has a second filter 206 transmitting light of the second color component, and the third detecting element has a third filter 206 transmitting light of the third color component.

The plurality of filters 102 may include the first filter, the second filter, and the third filter. For example, the first filter transmits light in a part of the wavelength region that the first detecting element can detect. The second filter transmits light in a part of the wavelength region that the second detecting element can detect. The third filter transmits light in a part of the wavelength region that the third detecting element can detect. In the stated case, the first filter of the filters 102 may transmit light in a part of the wavelength region that the first filter 206 can transmit. The second filter of the filters 102 may transmit light in a part of the wavelength region that the second filter 206 can transmit. The third filter of the filters 102 may transmit light in a part of the wavelength region that the third filter 206 can transmit.

For example, the light detector 204 includes an R detecting element, G detecting element, and a B detecting element respectively capable of detecting an R component (e.g. light in a wavelength range between 600 nm and 750 nm), a G component (e.g. light in a wavelength range between 490 nm and 600 nm), and a B component (e.g. light in a wavelength range between 420 nm and 490 nm) of light. Here, when there are a plurality of image capturing apparatuses 20, the light detector 204 of one image capturing apparatus 20 may be different from the light detector 204 of another image capturing apparatus 20, in the spectroscopic characteristic for detecting the R component, the G component, and the B component of light.

The plurality of filters 102 include an R filter, a G filter, and a B filter, for example. The R filter transmits light in a part of the wavelength region that the R detecting element can detect. The G filter transmits light in a part of the wavelength region that the G detecting element can detect. The B filter transmits light in a part of the wavelength region that the B detecting element can detect. In other words, each of the plurality of filters 102 transmits light in the wavelength region in a narrower range than the wavelength region that each of the detecting elements can detect. Accordingly, the R detecting element, the G detecting element, and the B detecting element respectively detect light in a predetermined wavelength region that the R filter, the G filter, and the B filter respectively transmit, thereby enabling to capture the image of the check sheet 10.

The plurality of filters 102 may transmit light in the wavelength region that represents the color, before change, of the reagent contained in the reagent container 104, or in the wavelength region that represents the color after change. Specifically, the plurality of filters 102 may include a first filter and a second filter. The first filter transmits light in the wavelength region representing the color of the reagent before change. The second filter transmits light in the wavelength region representing the color of the reagent after change.

It is also possible to determine the wavelength region that each filter 102 transmits, by measuring, in advance, the intensity distribution for each wavelength of light emitted by the reagent. In addition, when the color of the reagent changes from the first color to the second color, it is possible to design so that the first filter transmits light in a wavelength region representing the first color, and the second filter transmits light in a wavelength region representing the second color. It is also possible to determine a wavelength region that each filter 102 transmits, depending on the spectroscopic characteristic that the light detector 204 exhibits. Moreover, a compound emitting a color of light in a wavelength region that each filter 102 transmits may be used as a reagent.

In another embodiment, a light reflective section may be provided at an opposite side of the filters 102 with respect to the reagent container 104, for reflecting light incident from the filters 102 as well as for transmitting a target element through the reagent container 104. This provision of the light reflective section enables an image capturing apparatus 20 to adequately capture the color of the reagent contained in the reagent container 104, even when the quantity of light irradiated onto the check sheet 10 is small.

The image capturing apparatus 20 captures the image of the plurality of filters 102 of the check sheet 10. The image capturing apparatus 20 captures the image of light in a wavelength region transmitted through the filters 102. The captured image data showing the image captured by the image capturing apparatus 20 is transmitted, via a network 50 such as LAN and the Internet, to the analyzing apparatus 30 that determines the skin condition by analyzing the captured image. The image capturing apparatus 20 may be contained in a cradle connectable to the image capturing apparatus 20 from a telecommunication point of view. The cradle is connected to the analyzing apparatus 30 via the network 50 to be communicable. In the stated case, the image capturing apparatus 20 may transmit the captured image data to the analyzing apparatus 30 via the cradle.

The analyzing apparatus 30 analyzes the condition of the skin 40 from the image of the check sheet 10 captured by the image capturing apparatus 20. The analyzing apparatus 30 may be a PC or a server. Specifically, the analyzing apparatus 30 analyzes the quantity of light transmitted through the filters 102, e.g. the quantity of light transmitted through each of the filter 102R transmitting light of R component, the filter 102G transmitting light of G component, the filter 102B transmitting light of B component, from the captured image shown by the captured image data. The analyzing apparatus 30 determines the quantity of water on the surface of the skin 40, depending on a color component, the light quantity of which is the largest. The analyzing apparatus 30 generates notification information, thereby notifying the user of the analysis result.

For example, the reagent contained in the reagent container 104 may be anhydrous copper sulfate. Anhydrous copper sulfate is colorless, but changes into blue by being changed into copper sulfate pentahydrate upon absorption of water. Based on the color change of copper sulfate, the water quantity or the water evaporation quantity of the skin 40 can be calculated by the change in received light quantity of R component having passed through the filter 102R.

The reagent contained in the reagent container 104 may desirably be a color material, the maximum absorption wavelength of which is comparatively consistent with respect to the wavelength dependency of the detection sensitivity of the RGB components of a digital camera being one example of the image capturing apparatus 20. For example, a color material such as nitrotetrazolium blue (NTB) and diarylimidazole leuco dye may be used. Nitrotetrazolium blue (NTB) is initially slightly yellowish, but changes into red having the maximum absorption wavelength around 540 nm due to the light fog/reduction reaction. Diarylimidazole leuco dye is initially colorless, but changes into blue having the maximum absorption wavelength around 650 nm due to light fog/reduction reaction. Using the stated color materials, the condition of the skin 40 can be accurately determined based on the quantity of light transmitted through the filter 102R, the filter 102G, and the filter 102B respectively.

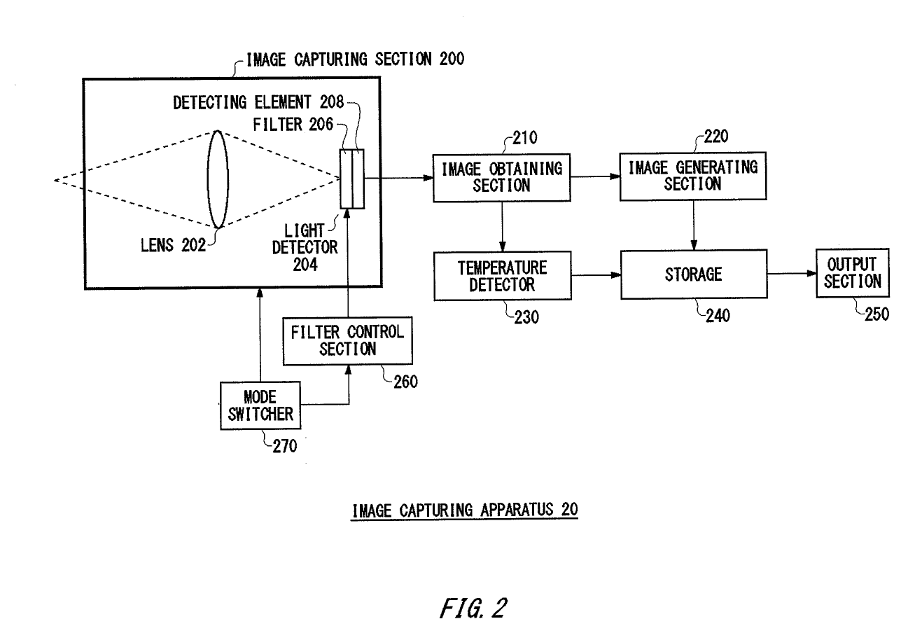

FIG. 2 shows an exemplary functional configuration of an image capturing apparatus 20 according to the present embodiment. The image capturing apparatus 20 includes an image capturing section 200, an image obtaining section 210, an image generating section 220, a temperature detector 230, a storage 240, an output section 250, a filter control section 260, and a mode switcher 270. The image capturing section 200 includes a lens 202 and a light detector 204. The light detector 204 includes a filter 206 and a detecting element 208. Note that the light detector 204 may include a plurality of filters 206 and a plurality of detecting elements 208, and each of the filters 206 may be placed in correspondence with a corresponding one of the detecting elements 208.

The image capturing section 200 captures the image of the check sheet 10. The image capturing section 200 captures a visible light image and an infrared light image of the check sheet 10. Specifically, the image capturing section 200 causes the light detector 204 to receive light incident from the image capturing range, via the lens 202. The light detector 204 captures an image of the check sheet 10 contained in the image capturing range, by receiving light at the plurality of detecting elements 208. The image capturing section 200 may also capture the image of the check sheet 10, by receiving light transmitted through the infrared light filter. That is, the image capturing section 200 captures the image of the check sheet 10, by causing the detecting elements 208 to receive light from the check sheet 10 contained in the image capturing range, through the lens 202 and the infrared light filter. Note that the lens 202 may be a lens system composed of a plurality of lenses.

Note that a visible light image is obtained through light received by the detecting elements 208 included in the light detector 204 of the image capturing section 200 within the visible light wavelength range, e.g. within the wavelength range of 400 nm to 700 nm. An infrared light image is obtained through light received by the detecting elements 208 included in the light detector 204 of the image capturing section 200 within the infrared light wavelength range, e.g. within the wavelength range of 700 nm to 1000 nm, or within the wavelength range of 700 nm to 2500 nm. The image capturing region represents a region within which a visible light image and an infrared light image can be captured by the image capturing section 200, and includes at least a plurality of filters 102 of the check sheet 10. In addition, the image in the present embodiment may include a moving image, not only a still image. A moving image contains a plurality of moving image constituting images. An exemplary moving image constituting image is a frame image or a field image.

Specifically in the light detector 204, a plurality of visible light detecting elements 208 for capturing an image by receiving visible light may be arranged on the same plane on which a plurality of infrared light detecting elements for capturing an image by receiving infrared light are arranged. Note that an exemplary light detector 204 is a CCD or a plurality of CMOS sensors. Here, the filter 206 includes a plurality of filters 206. Specifically, the filter 206 may be a primary color filter, e.g. a filter transmitting light of R component, G component, and B component, or a complementary color filter, e.g. a filter transmitting light of C (Cyan) component, M (Magenta) component, Y (Yellow) component, and G (Green) component. Furthermore, the filter 206 may include both of a primary color filter and a complementary color filter.

The filter 206 may include an infrared light filter blocking the infrared light out of the light from the check sheet 10. In addition, the filter 206 may include filters respectively for transmitting light in a visible light region and light in an infrared light region, out of the light from the check sheet 10. The light detector 204 may be set so as to receive light in a wavelength region that is wider than the wavelength region representing the color component that changes by contact of the reagent container 104 with the target element, and that each of the filters 102 transmits.

The reagent contained in the reagent container 104 of the check sheet 10 may at least be a compound exhibiting the color of light of a center wavelength in the wavelength region that each of the filters 206 transmits. For example, suppose a case where the filter 206 includes a filter 206R transmitting light in an R component wavelength region, a filter 206G transmitting light in a G component wavelength region, and a filter 206B transmitting light in a B component wavelength region. In this case, the reagent contained in the reagent container 104 may include a compound exhibiting a color of light of a center wavelength in the wavelength region that the filter 206R transmits, a compound exhibiting a color of light of a center wavelength in the wavelength region that the filter 206G transmits, and a compound exhibiting a color of light of a center wavelength in the wavelength region that the filter 206B transmits.

In the present example, the light irradiated onto the check sheet 10 is white light emitted from a fluorescent lamp or an incandescent lamp if indoors for example, and may be white light such as sunlight if outdoors. Regardless of indoors or outdoors, a halogen lamp, a xenon lamp, a flash lamp for photography, and a tungsten lamp may also be used. Here, the light source may individually emit light in respective wavelength regions of R component, G component, and B component, for example. In the stated case, the image capturing apparatus 20 may capture an image of the same check sheet 10 within a predetermined time, in respective cases of sequentially irradiating the light of R component, irradiating the light of G component, and irradiating the light of B component.

The image capturing apparatus 20 may generate information identifying a wavelength range transmitted through the plurality of filters 102 of the check sheet 10, using the difference among a plurality of captured images. For example, the image capturing apparatus 20 may generate information indicating the color of the reagent, by taking a difference between an analogue electric signal indicated by the light captured by the detecting element 208 while the check sheet 10 is irradiated with the light source emitting the light in the R component wavelength region, and an analogue electric signal indicated by the light captured by the detecting element while the check sheet 10 is irradiated with the light source emitting light in the G component wavelength region. By adopting the stated method, the light detector 204 does not have to include the filter 206. Note that the light source may be a light emitting diode (LED), which sequentially emits light in wavelength regions respectively of R component, G component, and B component, from a predetermined distance from the check sheet 10.

According to the stated configuration, if an aperture is provided in the vicinity of the filter 102 of the check sheet 10, so as to expose the skin 40 directly to outside, the image capturing apparatus 20 can also capture a high-definition image of the skin 40, not only detecting light having been transmitted through the plurality of filters 102.

The mode switcher 270 selects any of a check mode for capturing an image of the check sheet 10, and a normal mode for capturing an image other than the check sheet 10. Specifically, the mode switcher 270 selects one of the check mode and the normal mode, according to an instruction by a user. The mode switcher 270 controls the filter control section 260 in accordance with the selected mode. When the image capturing section 200 captures an image of the check sheet 10, the filter control section 260 controls the image capturing section 200 to receive light containing infrared light, without transmitting the light through the infrared light filter. Specifically, when the mode switcher 270 selects a check mode, the image capturing section 200 is controlled to receive light containing infrared light, without transmitting the light through the infrared light filter. Note that the filter 206 may be a wavelength variable filter. For example, the filter 206 may be a Fabry-Perrot filter. In another embodiment, the filter 206 may be a diffraction grating, a prism, or a filter having a plurality of narrowband filters.

The image obtaining section 210 reads an analogue electric signal from the plurality of detecting elements 208 included in the light detector 204. The image obtaining section 210 converts the read analogue electric signal to a digital signal, thereby obtaining the captured image in the image capturing range as captured image data. Specifically, the image obtaining section 210 extracts an analogue electric signal showing the captured image in the image capturing range, which has been captured by the image capturing section 200, by performing processing to alleviate the noise occurring in the light detector 204 to the analogue electric signal read from the light detection section 204. The image obtaining section 210 corrects the high and low portions of the extracted electric signal to a predetermined level. Next, the image obtaining section 210 obtains captured image data by converting the corrected analogue electric signal into a digital signal. The image obtaining section 210 supplies the obtained captured image data, to the image generating section 220 and the temperature detector 230.

The image obtaining section 210 may execute conversion processing from an analogue electric signal into a digital signal, after gamma conversion. The image obtaining section 210 may extract an analogue electric signal of each color of RGB from the analogue electric signal, and convert the extracted analogue electric signal into a digital signal. The image obtaining section 210 may execute white balance processing to determine the reference value of white in the captured image, in executing data compression processing to reduce the data quantity of the digital signal. The image obtaining section 210 generates an image of a brightness signal and a color difference signal from the RGB signal. Next, the image obtaining section 210 extracts, from the generated image, a portion, of which the signal change is larger than a predetermined reference value, to execute sharpness processing to the extracted portion. The image obtaining section 210 may execute data compression processing to the image after provided with the sharpness processing.

The image generating section 220 generates an image of the check sheet 10 from visible light received by the visible light detecting element. The image generating section 220 generates an image using the captured image data generated by the image obtaining section 210 by converting an analogue electric signal generated from the visible light received by the visible light detecting element, from among the captured image data obtained by the image obtaining section 210. Likewise, the image generating section 220 may generate an image from infrared light received by the infrared light detecting element. The image generating section 220 supplies image data indicating the generated image, to the storage 240.

The temperature detector 230 detects the temperature of the skin 40, from the infrared light received by the infrared light detecting element. Specifically, the temperature detector 230 calculates the temperature of the skin 40 from the infrared light image captured by the image capturing apparatus 20. Accordingly, when the color of the reagent contained in the reagent container 104 changes due to the temperature of the skin 40, the condition of the skin 40 can be determined more accurately. The temperature detector 230 supplies information indicating the calculated temperature to the storage 240. The storage 240 stores the image generated by the image generating section 220, in association with the temperature detected by the temperature detector 230. The output section 250 transmits, to the analyzing apparatus 30 via the network 50, image data showing the image stored in the storage 240 together with information indicating the temperature of the skin 40 at the time of capturing the image.

The analyzing apparatus 30 determines the condition of the skin 40 based on the image captured by the image capturing apparatus 20. The analyzing apparatus 30 may determine the condition of the skin 40, from the color of the reagent detected from the captured image of the check sheet 10 captured by the image capturing apparatus 20. Specifically, the analyzing apparatus 30 records, in advance, a color of a reagent and a condition of the skin 40. The analyzing apparatus 30 determines the color of light transmitted through the filters 102 of the check sheet 10 included in the image captured by the image capturing apparatus 20, thereby determining the condition of the skin 40 form the color. In addition, the analyzing apparatus 30 may record, in advance, a temperature of the skin 40 in association with a color of a reagent. The analyzing apparatus 30 may determine the condition of the skin 40 from the temperature of the skin 40 and the color of the reagent.

The analyzing apparatus 30 may include a quantity calculating section for calculating the quantity of a target element, based on the quantity of light detected by the light detector 204. Specifically, the analyzing apparatus 30 may further include a quantity storage for storing correlation information indicating a correlation between the quantity of light in a part of the wavelength region from the reagent container 104 and the quantity of a target element. The quantity calculating section of the analyzing apparatus 30 may determine the quantity of the target element, based on the quantity of light detected by the light detector 204 and the correlation information stored in the quantity storage.

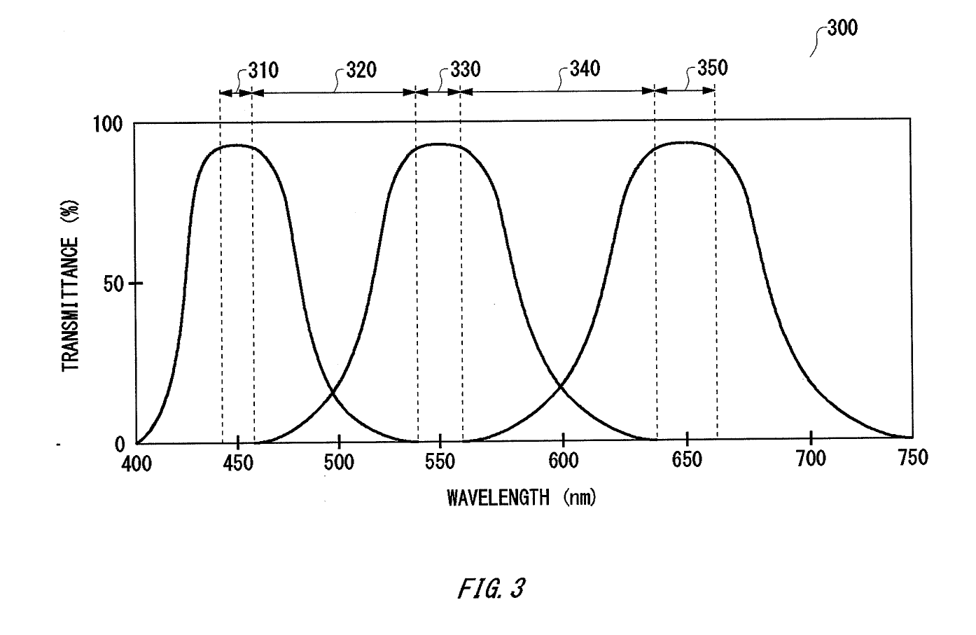

FIG. 3 shows an exemplary conception of the light transmission characteristic of a plurality of filters 102 according to the present embodiment. The reagent contained in the reagent container 104 exhibits the color of light in the wavelength region between 420 nm and 490 nm, for example. By being in contact with the target element generated from the skin 40, the reagent exhibits the color in the wavelength region between 490 nm and 600 nm, or the color in the wavelength region between 600 nm and 750 nm. Note that as well as exhibiting the color within the wavelength region between 600 nm and 750 nm, the reagent may exhibit the color in the wavelength region between 420 nm and 490 nm, when the target element generated by the skin 40 is brought into contact with the reagent.

In the stated case, the first filter, e.g. R filter, transmits only light in a part of the wavelength region of light exhibited by the reagent. For example, the first filter transmits only light included in the wavelength region 350. The second filter, e.g. G filter, transmits only light included in a part of the wavelength region of light exhibited by the reagent. For example, the second filter transmits only light included in the wavelength region 330. The third filter, e.g. B filter, transmits only light in a part of the wavelength region of light exhibited by the reagent. For example, the third filter transmits only light included in the wavelength region 310.

Note that each of the first filter, the second filter, and the third filter may transmit light in a predetermined wavelength region, with its center being the peak wavelength of the light exhibited by the reagent. In the stated case, it is desirable to design wavelength regions of light respectively transmittable through the first filter, the second filter, and the third filter, without any overlap between them.

The plurality of filters 102 according to the present embodiment transmit only light in a predetermined wavelength region from among respective wavelength regions of R component, G component, and B component. Accordingly, even when the spectroscopic characteristic of the filter 206 of the light detector 204 is different among different image capturing apparatuses 20, the change in color of the reagent can be assuredly detected regardless of the difference in filter 206. That is, the plurality of filters 102 of the check sheet 10 do not transmit light in the mixture wavelength region (e.g. wavelength region 320) where the B component wavelength region and the G component wavelength region are mixed, or light in the mixture wavelength region (e.g. wavelength region 340) where the G component wavelength region and the R component wavelength region are mixed. Therefore, the analyzing apparatus 30 does not detect the color of the reagent in the middle of change, and can detect assured change of the color of the reagent. By using the check sheet 10 according to the present embodiment, it becomes possible to determine the condition of the skin 40 without ambiguity.

Each of the filters 102 is able to transmit light in a part of a corresponding one of the plurality of wavelength regions detectable by the light detector 204, which includes at least a part of a wavelength region representing the intensity of light from the reagent larger than a predetermined value. For example, the wavelength region 330 may be a part of the wavelength region detectable by the detecting element 208 detecting the light of R component as well as a region where the intensity of light from the reagent is larger than a predetermined value. The wavelength region 320 may be a part of the wavelength region detectable by the detecting element 208 detecting the light of G component as well as a region where the intensity of light from the reagent is larger than a predetermined value. The wavelength region 310 may be a part of the wavelength region detectable by the detecting element 208 detecting the light of B component as well as a region where the intensity of light from the reagent is larger than a predetermined value.

The filter 102 may transmit light in a part of the wavelength region detectable by the light detector 204 that includes a wavelength region where the intensity of light from the reagent takes the extreme value or the maximum value. The filter 102 may also transmit light including a part of the wavelength region detectable by the light detector 204, where the intensity of light from the reagent takes the extreme value or the maximum value.

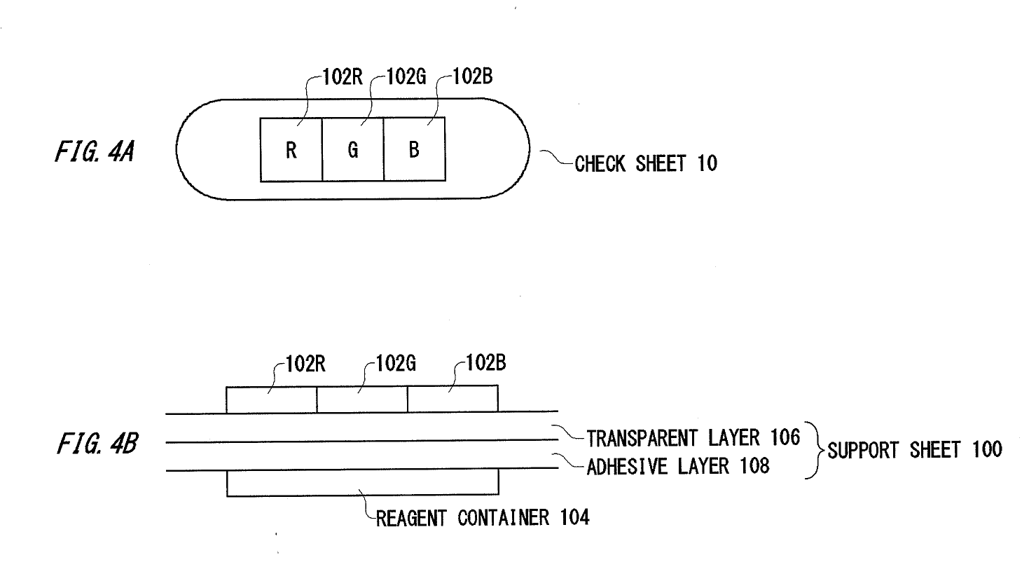

FIGS. 4A and 4B show an exemplary check sheet 10 according to the present embodiment. A plurality of filters 102 of the check sheet 10 are a filter 102R transmitting light in an R component wavelength region, a filter 102G transmitting light in a G component wavelength region, and a filter 102B transmitting light in a B component wavelength region. The filter 102R, the filter 102G, and the filter 102B are disposed to be adjacent to each other on the check sheet 10, for example as shown in FIG. 4A. Note that the filter 102R, the filter 102G, and the filter 102B may be arranged in a different order from the order shown in the drawings.

The support sheet 100 includes a transparent layer 106 and an adhesive layer 108. The transparent layer 106 may be a polymeric resin sheet just as the material explained for the support sheet 100 of FIG. 1 which transmits both of light in the visible light region and light in the infrared light region. The adhesive layer 108 may be an acrylic adhesive. The filter 102R, the filter 102G, and the filter 102B may be disposed to be adjacent to each other on the upper surface of the transparent layer 106. Moreover, a reagent container 104 may be attached on the surface of the adhesive layer 108 facing the filter 102R, the filter 102G, and the filter 102B, for example as shown in FIG. 4B.

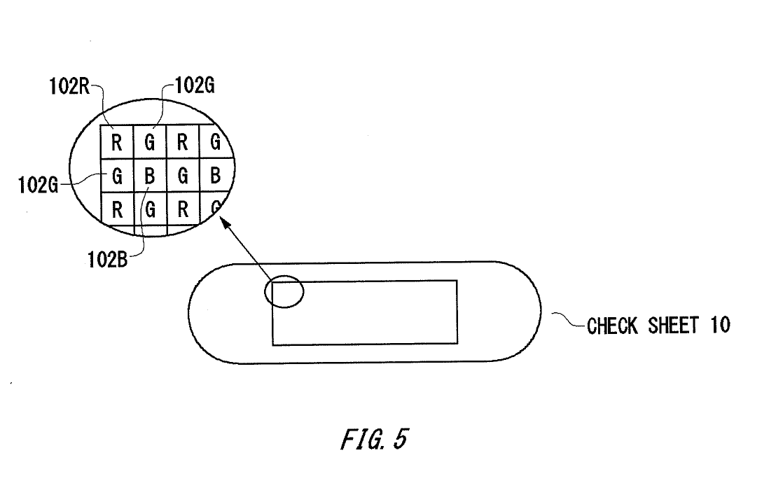

FIG. 5 shows an exemplary check sheet 10 according to the present embodiment. The filter 102 of the check sheet 10 may include a plurality of filters 102R transmitting light in an R component wavelength region, a plurality of filters 102G transmitting light in a G component wavelength region, and a plurality of filters 102B transmitting light in a B component wavelength region, where the R component wavelength region, the G component wavelength region, and the B component wavelength region are an example of the first wavelength region, the second wavelength region, and the third wavelength region, respectively.

Specifically, as illustrated, the filter 102 may have a lattice formation of a predetermined number of rows and columns made up of the filters 102R, the filters 102G, and the filters 102B. For example, a unit lattice is made up of a filter 102R positioned in the first row, the first column, a filter 102G positioned in the first row, the second column, a filter 102G positioned in the second row, the first column, and a filter 102B positioned in the second row, the second column. The filter 102 may be composed of a plurality of the unit lattices. Note that the number of the kind of the filters included in a unit lattice is not limited to as described above, and a single unit lattice may be made up of more filters 102.

In this way, the plurality of filters 102 of the check sheet 10 are provided in a matrix formation on the opposite side to the side of the reagent container 104 to be attached to the skin. Specifically, the plurality of filters 102R, the plurality of filters 102G, and the plurality of filters 102B are provided in a matrix formation on the opposite side to the side of the reagent container 104 to be attached to the skin. Note that the filters 102R, the filters 102G, and the filters 102B may respectively be one example of the first filter, the second filter, and the third filter of the present invention.

The analyzing apparatus 30 may analyze the condition of the skin 40 based on the intensity distribution of each color component in the mage, having been obtained by a plurality of detecting elements 208 by detecting the light of each color component. Specifically, the analyzing apparatus 30 may analyze the condition of the skin 40, based on the intensity histogram of each color component in an image. For example, the analyzing apparatus 30 can analyze the distribution of the condition of the skin 40 based on the R component intensity distribution, the G component intensity distribution, and the B component intensity distribution in the visible light image. In this way, according to the check sheet 10 having the present configuration, it becomes possible to analyze the spatial distribution such as a water quantity or a sebum quantity on the surface of the skin 40.

In addition, the analyzing apparatus 30 may calculate a representative value of the intensity of each color component, based on the intensity distribution of each color component in an image. An example of the representative value of the intensity may be an average of the intensity, a median of the intensity distribution, and a maximum frequency showing the intensity having the maximum level frequency of the intensity frequency distribution. The analyzing apparatus 30 may analyze the condition of the skin 40 within the region where the reagent container 104 is in contact with the skin 40 based on the representative value of the intensity of each color component. Therefore, according to the check sheet 10 having the present configuration, it becomes possible to reduce the effect, on the analysis result, of a spatial variation such as a water quantity, a sebum quantity, or the like on the surface of the skin 40.

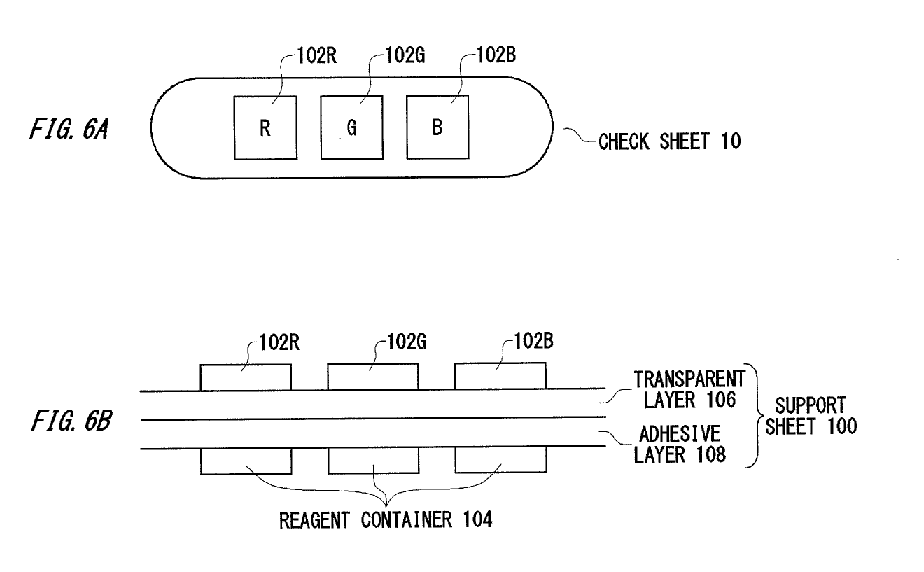

FIGS. 6A and 6B show an exemplary check sheet 10 according to the present embodiment. Each of the filters 102 of the check sheet 10 includes a filter 102R, a filter 102G, and a filter 102B. The filter 102R, the filter 102G, and the filter 102B are disposed on the check sheet 10 with a predetermined distance therebetween, for example as shown in FIG. 6A. Note that the filter 102R, the filter 102G, and the filter 102B may be arranged in a different order from the order shown in the drawings. Although a plurality of filters 102 are arranged along the long axis direction of the check sheet 10 in FIG. 6A, the filters 102 may also be arranged along the short axis direction of the check sheet 10 in another embodiment.

The filter 102R, the filter 102G, and the filter 102B may be attached to on the upper surface of the transparent layer 106, with a predetermined distance therebetween. Moreover, a plurality of reagent containers 104 may be attached to the surface of the adhesive layer 108 at respective positions facing the filter 102R, the filter 102G, and the filter 102B, as shown in FIG. 6B. Accordingly, the analyzing apparatus 30 can analyze the condition of each of a plurality of positions of the skin 40 at once. Note that it is also possible to arrange so that a plurality of filters 102R, a plurality of filters 102G, and a plurality of filters 102B are provided in a matrix formation on the opposite side to the sides of a plurality of reagent containers 104 to be attached to the skin and in respective positions facing the plurality of reagent containers 104, just as in FIG. 5.

Here as shown in FIG. 6B, the plurality of reagent containers 104 are attached above the surface of the adhesive layer 108 with a predetermined distance therebetween. By providing the plurality of reagent containers 104 to be separated from each other, it is occasionally possible to prevent the reaction between a reagent and a target element in one reagent container 104 from affecting an adjacent reagent container 104. Note that also in the check sheet 10 explained with reference to FIGS. 4A and 4B, too, a plurality of reagent containers 104 may be provided on the surface of the adhesive layer 108 at respective positions facing the positions of the filter 102R, the filter 102G, and the filter 102B, with a predetermined distance therebetween.

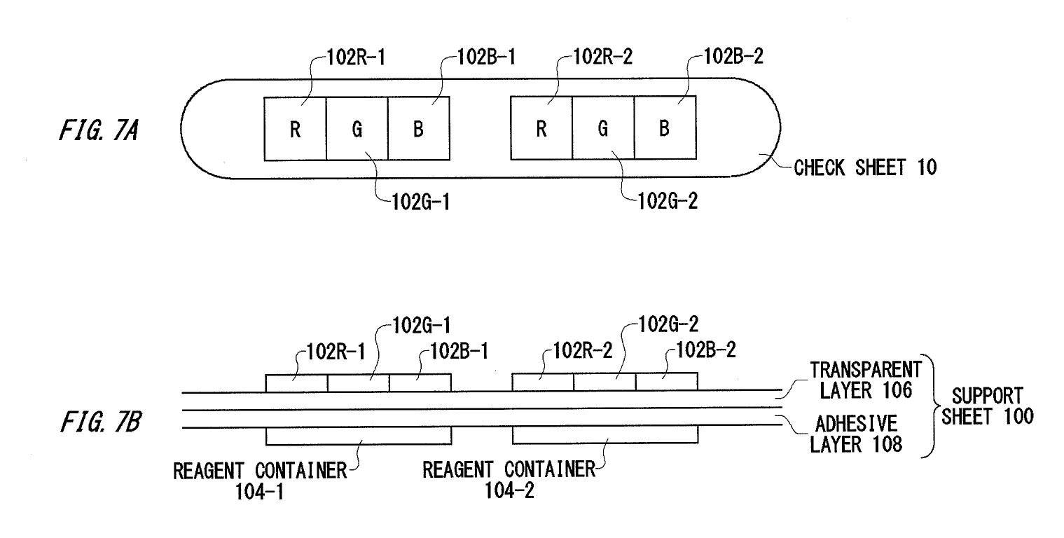

FIGS. 7A and 7B show an exemplary check sheet 10 according to the present embodiment. The check sheet 10 includes a plurality of filters 102-1 and 102-2, and a plurality of reagent containers 104-1 and 104-2. The plurality of reagent containers 104-1 and 104-2 may contain different kinds of reagents from each other. For example, the reagent container 104-1 contains anhydrous copper sulfate or cobalt chloride, while the reagent container 104-2 contains a pH indicator.

The filters 102-1 and 102-2 are provided respectively in association with the reagent containers 104-1 and 104-2. The filter 102-1 is provided to face the reagent container 104-1, and transmits light from the reagent contained in the reagent container 104-1. The filter 102-2 is provided to face the reagent container 104-2, and transmits light from the reagent contained in the reagent container 104-2.

The configuration and the function of the filters 102-1 and 102-2 are the same as the configuration and the function of the filter 102 explained above. The configuration and the function of the reagent containers 104-1 and 104-2 are also the same as the configuration and the function of the reagent container 104 explained above. The relation between the filter 102-1 and the reagent container 104-1, as well as the relation between the filter 102-2 and the reagent container 104-2 are the same as the relation between the filter 102 and the reagent container 104 explained above.

A plurality of filters 102R, a plurality of filters 102G, and a plurality of filters 102B may be provided in a matrix formation on the opposite side to the side of the reagent container 104-1 to be attached to the skin, as shown in FIG. 5. Moreover, a plurality of filters 102R, a plurality of filters 102G, and a plurality of filters 102B may be provided in a matrix formation on the opposite side to the side of the reagent container 104-2 to be attached to the skin, as shown in FIG. 5.

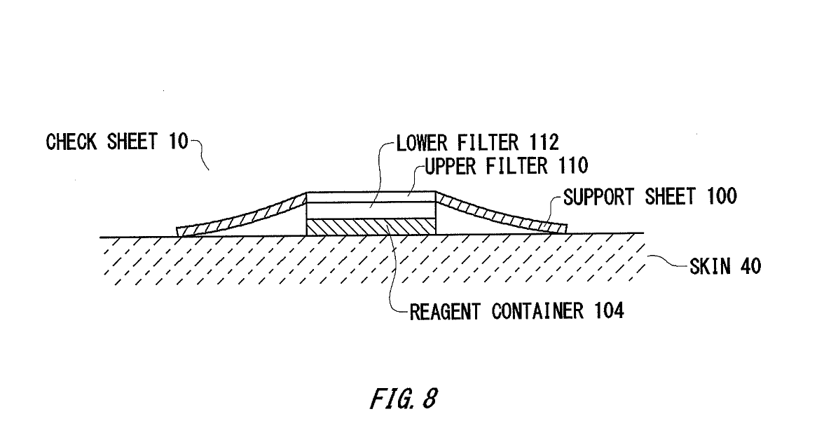

FIG. 8 shows one exemplary sectional view of a check sheet 10 according to the present embodiment. The check sheet 10 according to the present embodiment includes a reagent container 104 and a filter 102. The filter 102 is provided at the opposite side to the side of the reagent container 104 to be attached to the skin 40, and transmits light in a part of the wavelength region detectable by the light detector 204 detecting the color of the reagent. Here, the light detector 204 includes a first detecting element, e.g. R detecting element, capable of detecting the first color component of light, a second detecting element, e.g. G detecting element, capable of detecting the second color component of light, and a third detecting element, e.g. B detecting element, capable of detecting the third color component of light.

The filter 102 according to the present embodiment does not transmit light in a wavelength region detectable by both of the first detecting element and the second detecting element. In other words, the filter 102 does not transmit light in a wavelength region where the first color component overlaps the second color component. The filter 102 also does not transmit light in a wavelength region detectable by both of the second detecting element and the third detecting element. In other words, the filter 102 does not transmit light in a wavelength region where the second color component overlaps the third color component.

Specifically, the filter 102 includes an upper filter 110 and a lower filter 112 overlapped with each other above the reagent container 104. The upper filter 110 does not transmit light in a wavelength region detectable by both of the first detecting element and the second detecting element. For example, the upper filter 110 does not transmit light in a wavelength region detectable by both of the R detecting element and the G detecting element. The lower filter 112 does not transmit light in a wavelength region detectable by both of the second detecting element and the third detecting element. For example, the lower filter 112 does not transmit light in a wavelength region detectable by both of the G detecting element and the B detecting element. For example, the upper filter 110 blocks light in the wavelength region 340 shown by the graph 300 in the explanation given with reference to FIG. 3. In addition, the lower filter 112 blocks light in the wavelength region 320 shown by the graph 300 in the explanation given with reference to FIG. 3.

According to the above arrangement, the image capturing apparatus 20 will not capture the image of both of the wavelength region where the R component light is mixed with the G component light, and the wavelength region where the G component light is mixed with the B component light, so that the image capturing apparatus 20 can only capture the image where the color of the reagent has assuredly changed. Accordingly, the analyzing apparatus 30 does not have to determine the condition of the skin 40 based on minute changes in color, and so can more assuredly determine the condition of the skin 40.

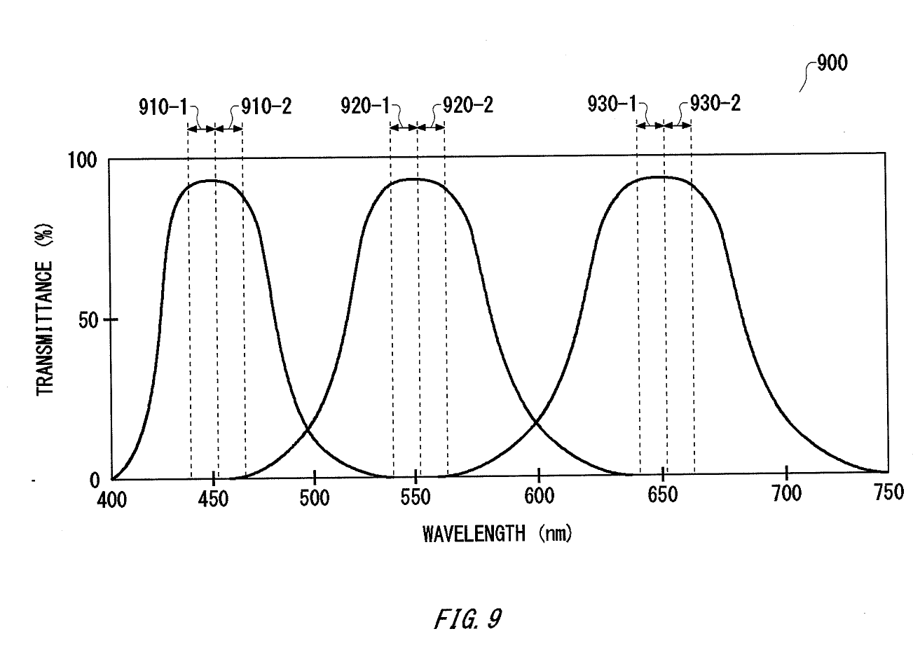

FIG. 9 shows another example of the light transmission characteristics of a plurality of filters 102 according to the present embodiment. The first filter, e.g. filter 102R, includes a plurality of partial wavelength region filters transmitting light in different wavelength regions. The plurality of partial wavelength region filters transmit light in a partial wavelength region 930-1 and a partial wavelength region 930-2, respectively. Here, the partial wavelength region 930-1 and the partial wavelength region 930-2 are an example of a plurality of different partial wavelength regions included in a wavelength region detectable by the detecting element 208 receiving R component light, which do not overlap with each other.

The second filter, e.g. filter 102G, includes a plurality of partial wavelength region filters transmitting light in different wavelength regions. The plurality of partial wavelength region filters transmit light in a partial wavelength region 920-1 and a partial wavelength region 920-2, respectively. Here, the partial wavelength region 920-1 and the partial wavelength region 920-2 are an example of a plurality of different partial wavelength regions included in a wavelength region detectable by the detecting element 208 receiving G component light, which do not overlap with each other.

The third filter, e.g. filter 102B, includes a plurality of partial wavelength region filters transmitting light in different wavelength regions. The plurality of partial wavelength region filters transmit light in a partial wavelength region 910-1 and a partial wavelength region 910-2, respectively. Here, the partial wavelength region 910-1 and the partial wavelength region 910-2 are an example of a plurality of different partial wavelength regions included in a wavelength region detectable by the detecting element 208 receiving B component light, which do not overlap with each other.

In this way, the plurality of filters 102 may include a plurality of partial wavelength region filters respectively transmitting light in a plurality of different partial wavelength regions respectively included in a plurality of partial wavelength regions, respectively in a plurality of different wavelength regions respectively detectable by the plurality of detecting elements 208 capable of detecting light in different color components of the light detector detecting the color of the reagent. Note that the plurality of filters 102 may include a plurality of partial wavelength region filters respectively transmitting light in a plurality of different partial wavelength regions included in a wavelength region detectable by at least one detecting element 208 of the plurality of detecting elements 208 capable of detecting light in different color components of the light detector 204 detecting the color of the reagent.

According to the check sheet 10 including the filter 102 having this light transmission characteristic, it is possible to detect respective intensities of light in a plurality of partial wavelength regions included in the wavelength region, by using a plurality of light detecting elements 208 detecting the light in the substantially the same wavelength region. Therefore, the spectroscopic image capturing in a narrowband is realized without using an image capturing apparatus for the purpose of narrowband spectroscopic image capturing. The analyzing apparatus 30 can occasionally analyze the quantity of the different components on the skin 40 individually, based on respective intensities of light in a plurality of partial wavelength regions. For example, the analyzing apparatus 30 can occasionally calculate the first component quantity on the skin 40 emitting light in the first partial wavelength region and the second partial wavelength region as well as the second component quantity emitting the second partial wavelength region but not substantially emitting light in the first partial wavelength region. In this way, according to the check sheet 10 including the filter 102 having this light transmission characteristic, when the analyzing apparatus 30 calculates the water quantity or the sebum quantity of the skin 40, it becomes occasionally possible to reduce the effect, on the calculated value of the water quantity or the calculated value of the sebum quantity, of the component of the cosmetics on the skin 40.

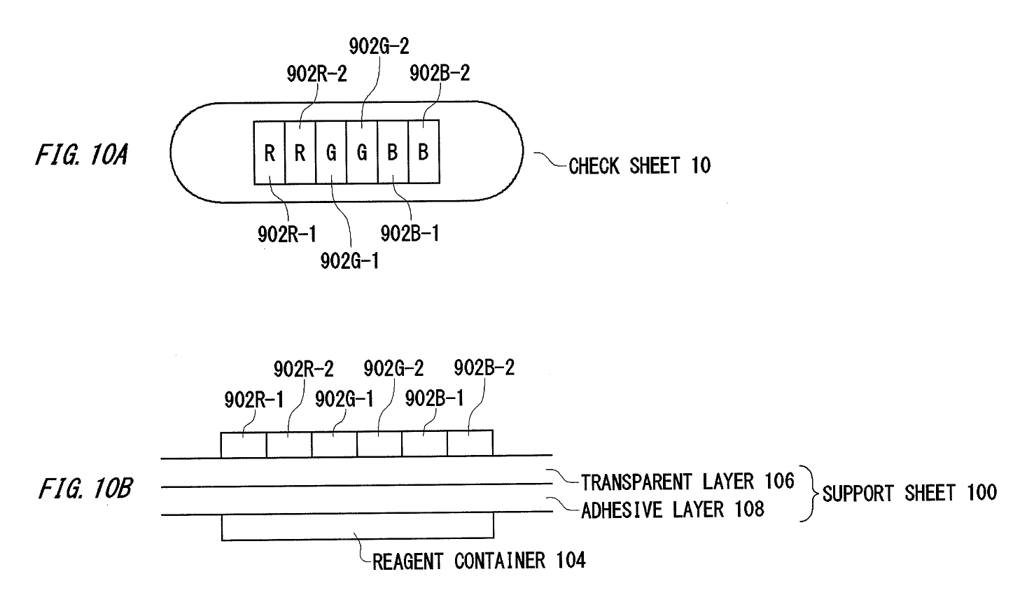

FIGS. 10A and 10B show a check sheet 10. These drawings show an exemplary configuration of a filter 102 having the light transmission characteristic explained above with reference to FIG. 9. A partial wavelength region filter 902R-1 and a partial wavelength region filter 902R-2 respectively transmit light in a partial wavelength region 930-1 and a partial wavelength region 930-2. A partial wavelength region filter 902G-1 and a partial wavelength region filter 902G-2 respectively transmit light in a partial wavelength region 920-1 and a partial wavelength region 920-2. A partial wavelength region filter 902B-1 and a partial wavelength region filter 902B-2 respectively transmit light in a partial wavelength region 910-1 and a partial wavelength region 910-2.

The check sheet 10 explained with reference to the present drawings are provided with partial wavelength region filters 902R-1 and 902R-2, instead of the filter 102R of the check sheet 10 explained above with reference to FIGS. 4A and 4B. Moreover, the check sheet 10 in the present drawings is provided with partial wavelength region filters 902G-1 and 902G-2, instead of the filter 102G. Moreover, the check sheet 10 in the present drawings is provided with partial wavelength region filters 902B-1 and 902B-2, instead of the filter 102B. In addition to the above, the partial wavelength region filters 902R-1, 902R-2, 902G-1, 902G-2, 902B-1, and 902B-2 of the present drawings can be provided in an arrangement similar to the arrangement explained above with reference to the present drawings, instead of the filters 102R, 102G, and 102B explained with reference to FIGS. 5, 6A, 6B, 7A, and 7B.

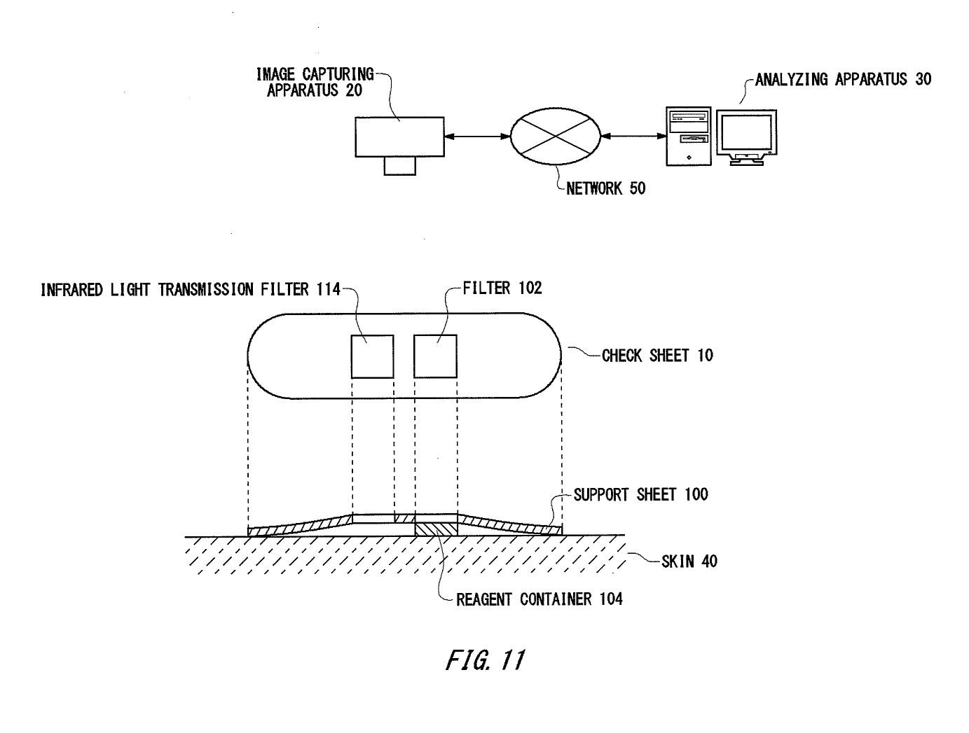

FIG. 11 shows an exemplary check system employing a check sheet 10 according to another embodiment of the present invention. In the present check system, the image capturing apparatus 20 captures an image of the check sheet 10 attached to the skin 40, and checks the condition of the skin 40. The check system includes a check sheet 10, an image capturing apparatus 20, and an analyzing apparatus 30. The check sheet 10 includes a support sheet 100, a filter 102, a reagent container 104, and an infrared light transmission filter 114.

Note that the check sheet 10 according to the present embodiment has substantially the same function and the configuration as those of the check sheet 10 explained above with reference to FIGS. 1-10B, except for addition of the infrared light transmission filter 114. Therefore, the constituting elements other than the infrared light transmission filter 114 are not detailed in the following. In addition, since the image capturing apparatus 20 and the analyzing apparatus 30 also have the same configuration and the function as those of the image capturing apparatus 20 and the analyzing apparatus 30 explained above with reference to FIGS. 1-10B, and so they will not be detailed in the following.

The infrared light transmission filter 114 is placed to be visible from outside together with the reagent container 104, and transmits the infrared light from the skin 40. The infrared light transmission filter 114 is provided to be adjacent to the reagent container 104 inside the surface of the check sheet 10. The infrared light transmission filter 114 may be provided inside the surface of the check sheet 10 to be apart from the reagent container 104 by a predetermined distance therebetween. In addition, the infrared light transmission filter 114 may be provided around the reagent container 104 inside the surface of the check sheet 10.

The infrared light transmission filter 114 transmits infrared light emitted from the skin 40. The image capturing apparatus 20 captures the image in the wavelength region transmitted through the filter 102, and captures the infrared light image of the skin 40 as well. The image capturing apparatus 20 transmits, via the network 50 to the analyzing apparatus 30, the captured image data of the captured image of the region of the filter 102 as well as the infrared light image data showing the infrared light image. The analyzing apparatus 30 analyzes the condition of the skin 40 from the captured image shown by the captured image data, as well as analyzing the temperature of the skin 40 from the infrared light image shown by the infrared light image data.

Accordingly, it is possible to measure the change in color of the reagent contained in the reagent container 104 and the temperature of the skin 40 at the same time. The analyzing apparatus 30 is able to accurately analyze the condition of the skin, by storing color information showing the color of a reagent, in association with the temperature of the skin 40 and the amount of the target element in contact with the reagent.

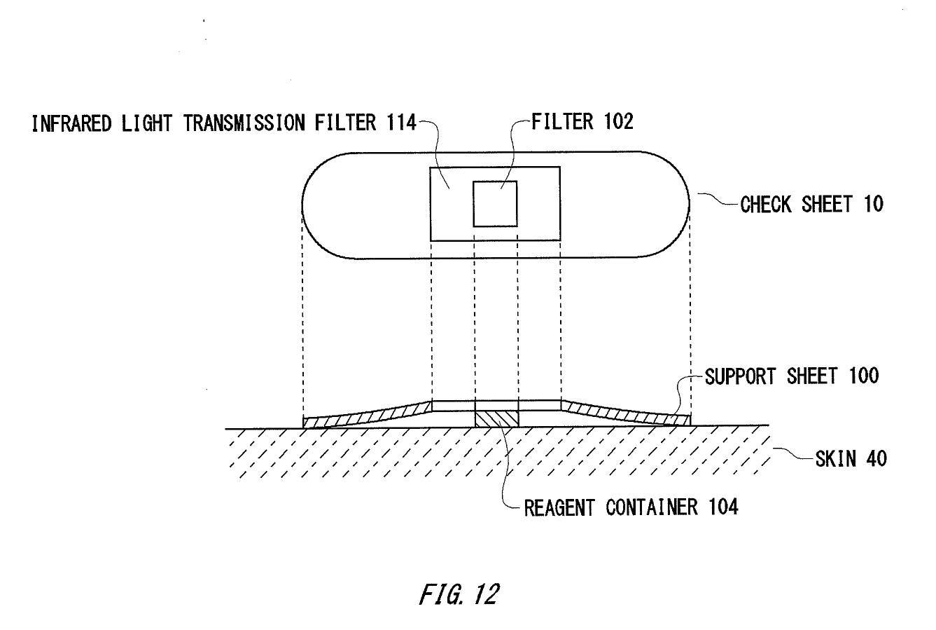

FIG. 12 shows an exemplary check sheet 10 according to another embodiment of the present invention. In the check sheet 10 according to the present embodiment, an infrared light transmission filter 114 is provided around the reagent container 104 within the surface of the check sheet 10. That is, the reagent container 104 is provided for the support sheet 100, and a filter 102 is provided for the support sheet 100 at the opposite side to the side of the reagent container 104 to be attached to the skin 40. The infrared light transmission filter 114 is provided around the filter 102 and in a range that does not exceed the region of the check sheet 10. The infrared light transmission filter 114 can take any form such as quadrangular, circular, polygonal, and a shape of a star.

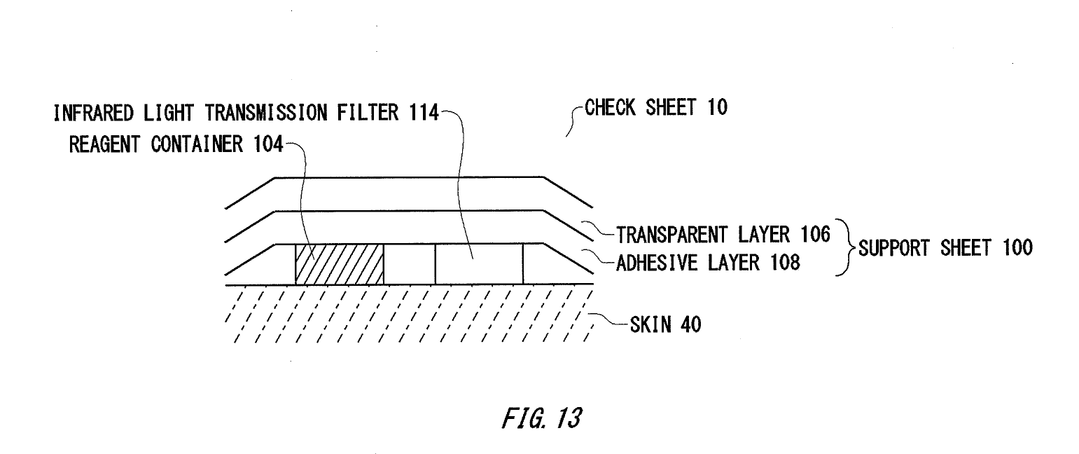

FIG. 13 shows an exemplary sectional view of a check sheet 10 according to another embodiment of the present invention. The check sheet 10 includes a support sheet 100, a filter 102, a reagent container 104, and an infrared light transmission filter 114. The support sheet 100 is formed by overlapping between a transparent layer 106 and an adhesive layer 108. Note that FIG. 13 does not show the filter 102 existing immediately above the reagent container 104, for the purpose of simplifying the explanation.

Specifically, the reagent container 104 and the infrared light transmission filter 114 are provided on the surface of the adhesive layer 108 to be attached to the skin 40. Therefore, in the check sheet 10 according to the present embodiment, the reagent container 104 and the infrared light transmission filter 114 will be positioned to attach to the skin 40. Note that it is possible to further provide a sheet for transmitting a target element, between the reagent container 104 or the infrared light transmission filter 114 and the skin 40, for preventing direct contact between the reagent container 104 or the infrared light transmission filter 114 and the skin 40.

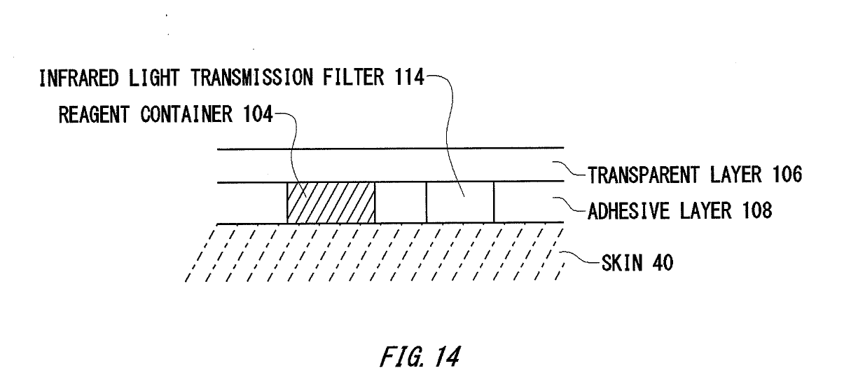

FIG. 14 shows an exemplary sectional view of a check sheet 10 according to another embodiment of the present invention. The check sheet 10 includes a transparent layer 106, an adhesive layer 108, a filter 102, a reagent container 104, and an infrared light transmission filter 114. The transparent layer 106 and the adhesive layer 108 are overlapped with each other. Note that FIG. 14 does not show the filter 102 existing immediately above the reagent container 104, for the purpose of simplifying the explanation.

Specifically, the reagent container 104 and the infrared light transmission filter 114 are provided inside the adhesive layer 108. That is, the reagent container 104 and the infrared light transmission filter 114 are surrounded by the adhesive layer 108 and the transparent layer 106, except for at least the area scheduled to be attached to the skin 40. Also, by the adhesive layer 108 being brought in contact with the skin 40, the reagent container 104 and the infrared light transmission filter 114 will be also brought in contact with the skin 40. According to the above-stated configuration, the entire thickness of the check sheet 10 can be made thin.

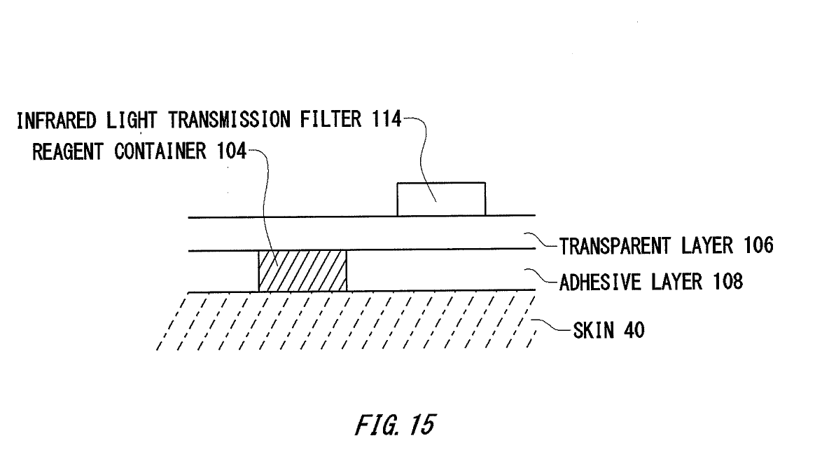

FIG. 15 shows an exemplary sectional view of a check sheet 10 according to another embodiment of the present invention. The check sheet 10 includes a transparent layer 106, an adhesive layer 108, a filter 102, a reagent container 104, and an infrared light transmission filter 114. The transparent layer 106 and the adhesive layer 108 are overlapped with each other. Note that FIG. 15 does not show the filter 102 existing immediately above the reagent container 104, for the purpose of simplifying the explanation.

Specifically, the reagent container 104 is provided inside the adhesive layer 108. By the adhesive layer 108 being brought in contact with the skin 40, the reagent container 104 will be also brought in contact with the skin 40. On the other hand, the infrared light transmission filter 114 is provided above the transparent layer 106 positioned at the opposite side to the side of the adhesive layer 108 attached to the skin 40. According to the stated structure, the image capturing apparatus 20 is able to capture an image enhancing infrared light from the skin 40 having been transmitted and/or scattered through the adhesive layer 108.

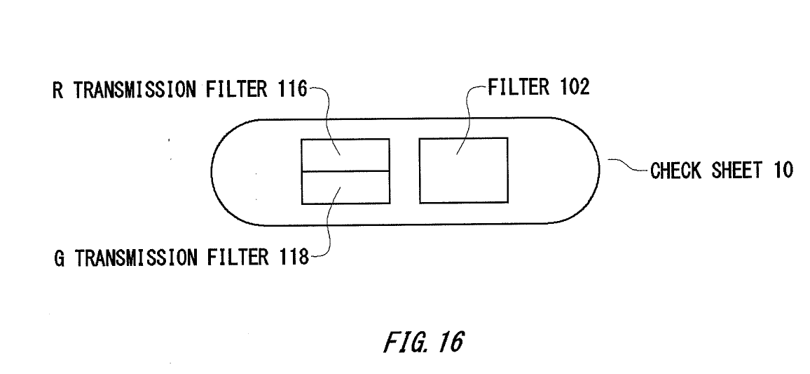

FIG. 16 shows an exemplary check sheet 10 according to another embodiment of the present invention. The check sheet 10 according to the present embodiment further includes an R transmission filter 116 and a G transmission filter 118, besides the filter 102 explained above with reference to FIGS. 1-15. The R transmission filter 116 is provided to be visible from outside together with the filter 102 and the G transmission filter 118, and transmits the R component light out of the light from the skin 40. For example, the R transmission filter 116 may transmit the R component light out of the color of hemoglobin. The G transmission filter 118 is provided to be visible from outside together with the filter 102 and the R transmission filter 116, and transmits the G component light out of the light from the skin 40. For example, the G transmission filter 118 may transmit the G component light out of the color of hemoglobin.

Here, the hemoglobin in the blood exists as oxygenated hemoglobin within an artery, and exists as reduced hemoglobin within a vein. A partial wavelength region of the reflection peak wavelength of the oxygenated hemoglobin is included in the G component, e.g. a wavelength region of 540 nm. On the other hand, a partial wavelength region of the reflection peak wavelength of the reduced hemoglobin is included in the R component, e.g. a wavelength region of 660 nm. Therefore, it is possible to determine the blood flow in the region of the skin 40, by analyzing the wavelength region of light transmitted through the R transmission filter 116 and the G transmission filter 118 of the check sheet 10.

Specifically, the image capturing apparatus 20 captures an image containing both of the R transmission filter 116 and the G transmission filter 118. The image capturing apparatus 20 transmits the captured image data showing the captured image, to the analyzing apparatus 30. The analyzing apparatus 30 analyzes the captured image shown by the captured image data, and analyzes the condition of the blood circulation in the region of the skin 40. For example, the analyzing apparatus 30 may include a blood circulation condition information storage recording, in advance, an intensity difference between the intensity of light in the R component wavelength region and the intensity of light in the G component wavelength region and information indicating the condition of blood circulation. The analyzing apparatus 30 analyzes the captured image data received from the image capturing apparatus 20, and calculates the intensity difference between the intensity of light in the R component wavelength region and the intensity of light in the G component wavelength region.

Next, the analyzing apparatus 30 extracts the information indicating the condition of a blood circulation stored in the blood circulation condition information storage in association with the calculated intensity, thereby determining the blood circulation condition in the region of the skin 40. Accordingly, it is possible to determine that the region of the skin 40 has experienced sunburn, the inflammation condition of the skin, or that the surface of the skin 40 is reddish after taking a bath or the like.

Although some aspects of the present invention have been described by way of exemplary embodiments, it should be understood that those skilled in the art might make many changes and substitutions without departing from the spirit and the scope of the present invention which is defined only by the appended claims. As clear from the foregoing, according to one embodiment of the present invention, it is possible to assuredly detect the phenomenon caused in the skin, even when any of different image capturing apparatuses has captured the color change of the check sheet.

What is claimed is:

1. A check sheet comprising:
a reagent container that contains a reagent that changes color by being brought into contact with a target element generated from skin; and
a plurality of filters provided in different positions from each other at the opposite side to the side of the reagent container to be attached to the skin along the reagent container, and emitting light in wavelength regions different from each other.

2. The check sheet as set forth in claim 1, wherein
the plurality of filters transmit light in a wavelength region representing a color of the reagent before change of color or a color of the reagent after change of color.

3. The check sheet as set forth in claim 2, wherein
the plurality of filters include:
a first filter that transmits light in a wavelength region indicating a color of the reagent before change of color; and
a second filter that transmits light in a wavelength region indicating a color of the reagent after change of color.

4. The check sheet as set forth in claim 1, wherein
the plurality of filters are provided in a matrix formation on the opposite side to the side of the reagent container to be attached to the skin.

5. The check sheet as set forth in claim 4, wherein
the plurality of filters include:
a plurality of first filters that transmit light in a first wavelength region; and
a plurality of second filters that transmit light in a second wavelength region, wherein
the plurality of first filters and the plurality of second filters are provided in a matrix formation on the opposite side to the side of the reagent container to be attached to the skin.

6. The check sheet as set forth in claim 1, wherein
the plurality of filters include:
a plurality of partial wavelength region filters respectively transmitting light in a plurality of different partial wavelength regions included in a wavelength region detectable by at least one of a plurality of detecting elements capable of detecting light of different color components included in a light detector that detects the color of the reagent.

7. The check sheet as set forth in claim 1, wherein
the plurality of filters include:
a plurality of partial wavelength region filters respectively transmitting light in a plurality of different partial wavelength regions respectively included in a plurality of different wavelength regions detectable by a plurality of detecting elements capable of detecting light in different color components, the plurality of detecting elements being included in a light detector detecting a color of the reagent.

8. The check sheet as set forth in claim 1, wherein
each of the plurality of filters transmits light in a part of a corresponding one of a plurality of wavelength regions detectable by a light detector detecting a color of the reagent.

9. The check sheet as set forth in claim 8, wherein
the light detector includes a first detecting element and a second detecting element respectively capable of detecting a first color component and a second color component of light, and
the plurality of filters include:
a first filter that transmits light in a part of a wavelength region detectable by the first detecting element; and
a second filter that transmits light in a part of a wavelength region detectable by the second detecting element.

10. The check sheet as set forth in claim 9, wherein
the light detector includes an R detecting element, a G detecting element, and a B detecting element respectively capable of detecting an R component, a G component, and a B component of light, and
the plurality of filters include:
an R filter that transmits light in a part of a wavelength region detectable by the R detecting element;
a G filter that transmits light in a part of a wavelength region detectable by the G detecting element; and
a B filter that transmits light in a part of a wavelength region detectable by the B detecting element.

11. The check sheet as set forth in claim 8, wherein
each of the plurality of filters transmits light in a part of a corresponding one of the plurality of wavelength regions detectable by the light detector, which includes at least a part of a wavelength region corresponding to an intensity of light from the reagent larger than a predetermined value.

12. A check sheet comprising:
a reagent container that contains a reagent that changes color by being brought into contact with a target element generated from skin; and
a filter provided at the opposite side to the side of the reagent container to be attached to the skin, and transmitting light in a part of a wavelength region detectable by a light detector detecting a color of the reagent.

13. The check sheet as set forth in claim 12, wherein
the light detector includes a first detecting element and a second detecting element respectively capable of detecting a first color component and a second color component of light; and
the filter does not transmit light in a wavelength region detectable by both of the first detecting element and the second detecting element.

14. The check sheet as set forth in claim 13, wherein
the light detector further includes a third detecting element capable of detecting a third color component of light,
the filter includes an upper filter and a lower filter overlapped with each other above the reagent container,
the upper filter does not transmit light in a wavelength region detectable by both of the first detecting element and the second detecting element, and
the lower filter does not transmit light in a wavelength region detectable by both of the second detecting element and the third detecting element.

15. The check sheet as set forth in claim 14, wherein
the light detector includes an R detecting element, a G detecting element, and a B detecting element respectively capable of detecting an R component, a G component, and a B component of light,
the upper filter does not transmit light in a wavelength region detectable by both of the R detecting element and the G detecting element, and
the lower filter does not transmit light in a wavelength region detectable by both of the G detecting element and the B detecting element.
